(19) United States
(12) Patent Application Publication
(10) Pub. No.: US 2022/0231316 A1
(43) Pub. Date: Jul. 21, 2022

(54) FUEL CELL SYSTEM

(71) Applicants: FUJI ELECTRIC CO., LTD., Kawasaki-shi (JP); MITSUBISHI POWER, LTD., Yokohama-shi (JP)

(72) Inventors: Kuniyuki TAKAHASHI, Kawasaki-shi (JP); Taichiro KATO, Kawasaki-shi (JP)

(73) Assignees: FUJI ELECTRIC CO., LTD., Kawasaki-shi (JP); MITSUBISHI POWER, LTD., Yokohama-shi (JP)

(21) Appl. No.: 17/711,005

(22) Filed: Mar. 31, 2022

Related U.S. Application Data
(63) Continuation of application No. PCT/JP2020/044501, filed on Nov. 30, 2020.

(30) Foreign Application Priority Data
Dec. 25, 2019 (JP) 2019-234467

(51) Int. Cl. H01M 8/04746; H01M 8/0432; H01M 8/04537; H01M 8/0444

(52) U.S. Cl. CPC H01M 8/04753; H01M 8/0432; H01M 2008/1293; H01M 8/04544; H01M 8/0444; H01M 8/04761

(57) ABSTRACT

A fuel cell system includes fuel cell stacks, each of which includes a plurality of fuel cells that are connected in series and generate electricity through an electrochemical reaction between a fuel gas and an oxidant gas, fuel cell cartridges, each of which has headers that supplies the fuel gas and the oxidant gas to the fuel cell stacks and discharges a fuel off-gas and an oxidant off-gas from the fuel cell stacks, a fuel gas supply line that supplies the fuel gas to the fuel cell cartridges, a fuel off-gas discharge line that discharges the fuel off-gas from the fuel cell cartridges, and a first adjustment member provided in the fuel gas supply line or the fuel off-gas discharge line, and adjusting a flow rate of the fuel gas or the fuel off-gas, the first adjustment member including a first flexible pipe.

### CROSS REFERENCE TO RELATED APPLICATIONS

This is a continuation application of International Application PCT/JP2020/044501 filed on Nov. 30, 2020 which claims priority from a Japanese Patent Application No. 2019-234467 filed on Dec. 25, 2019, the contents of which are incorporated herein by reference.

### BACKGROUND OF THE INVENTION

### Technical Field

The present invention relates to a fuel cell system.

### Background Art

Recently, the development of solid oxide fuel cells (SOFCs) is progressing. An SOFC is a power generation mechanism in which electrical energy is generated by causing oxide ions generated by an air electrode to pass through an electrolyte and move to a fuel electrode, such that the oxide ions react with hydrogen or carbon monoxide at the fuel electrode. SOFCs have the characteristics of having the highest operating temperatures for power generation (for example, from 900° C. to 1000° C.) and also the highest power-generating efficiency among currently known classes of fuel cells.

In the related art, a solid oxide fuel cell system has been proposed for a solid oxide fuel cell stack (SOFC stack) provided with a plurality of solid oxide fuel cell tubular cells (SOFC tubular cells), the solid oxide fuel cell system being provided with an orifice at the fuel inlet port to restrict the flow rate of the fuel introduced into each of the SOFC tubular cells (for example, see Patent Literature 1). According to this fuel cell system, it is possible to suppress inconsistencies in power generation due to non-uniform fuel supply with respect to each SOFC stack.

### CITATION LIST

### Patent Literature

Patent Literature 1: Japanese Patent Laid-Open No. 2015-185303

### SUMMARY OF INVENTION

### Technical Problem

By the way, recently, power generation methods using SOFCs have shown promise as a power generation method suited for reducing CO₂, and there is a demand to increase the capacity of the power output from SOFCs. For example, to achieve higher capacity of the power output from SOFCs, it is conceivable to construct a fuel cell cartridge (SOFC cartridge) by bundling a plurality of SOFC stacks each of which includes a plurality of solid oxide fuel cells (SOFC cells) connected in series, and adopt a fuel cell module provided with a plurality of such SOFC cartridges. Such a fuel cell cartridge includes a fuel supply header that supplies a fuel to the plurality of SOFC stacks, a fuel discharge header that discharges the fuel from the SOFC stacks, an oxidant gas supply header that supplies an oxidant gas, and an oxidant gas discharge header that discharges the oxidant gas from the SOFC stacks.

In the case where a fuel cell module is provided with a plurality of SOFC cartridges, achieving a uniform flow rate of the fuel to each of the SOFC cartridges (uniform distribution) is important for preventing degradation of the SOFC stacks (and furthermore the SOFC cells forming the SOFC stacks). In the case of applying the SOFC stack according to Patent Literature 1 to such a fuel cell module, the fuel flow rate is only adjustable for each SOFC stack at the orifice, making it difficult to achieve a uniform flow rate of the fuel to each of the SOFC cartridges (uniform distribution).

The present invention has been devised in the light of such circumstances, and one objective thereof is to provide a fuel cell system capable of achieving a uniform flow rate of the fuel to a plurality of fuel cell cartridges.

### Solution to Problem

A fuel cell system according to an aspect of the present invention is a fuel cell system using a plurality of fuel cell stacks each of which includes a plurality of fuel cells that generate electricity through an electrochemical reaction between a fuel gas and an oxidant gas connected in series, the fuel cell system comprising a plurality of fuel cell cartridges each of which supplies the fuel gas and the oxidant gas respectively to the plurality of fuel cell stacks through headers, and also discharges a fuel off-gas and an oxidant off-gas respectively through headers, a fuel gas supply line that supplies the fuel gas to the plurality of fuel cell cartridges, a fuel off-gas discharge line that discharges the fuel off-gas from the plurality of fuel cell cartridges, and a first adjustment member, provided in at least one of the fuel gas supply line or the fuel off-gas discharge line, that adjusts a flow rate of the fuel gas or the fuel off-gas, wherein at least one portion of the first adjustment member includes a flexible pipe.

### Advantageous Effects of Invention

According to the present invention, a uniform flow rate of the fuel to the fuel cell cartridges can be achieved.

### BRIEF DESCRIPTION OF DRAWINGS

FIG. 1 is a perspective view illustrating an example of a fuel cell module included in a fuel cell system according to the embodiments.

FIG. 2 is a plan view illustrating an example of a fuel cell module included in the fuel cell system according to the embodiments.

FIG. 3 is a block diagram illustrating a configuration of the fuel cell system according to a first embodiment.

FIG. 4 is a block diagram illustrating a configuration of the fuel cell system according to a second embodiment.

FIG. 5 is a block diagram illustrating a configuration of the fuel cell system according to a third embodiment.

FIG. 6 is a flowchart for describing a method of controlling flow rate adjustment valves in the fuel cell system according to a third embodiment.

### DESCRIPTION OF EMBODIMENTS

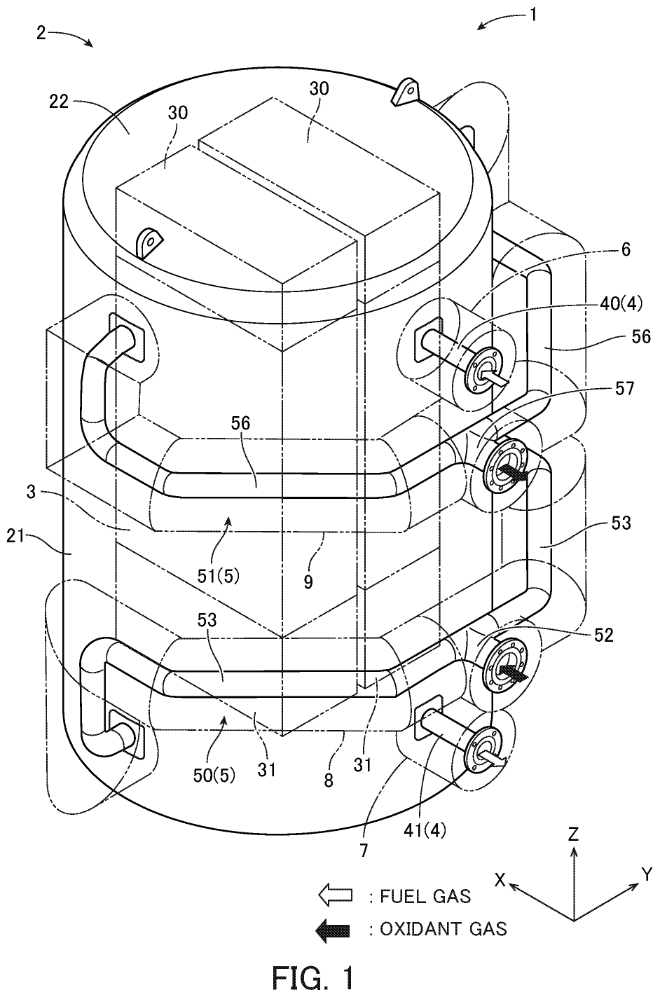

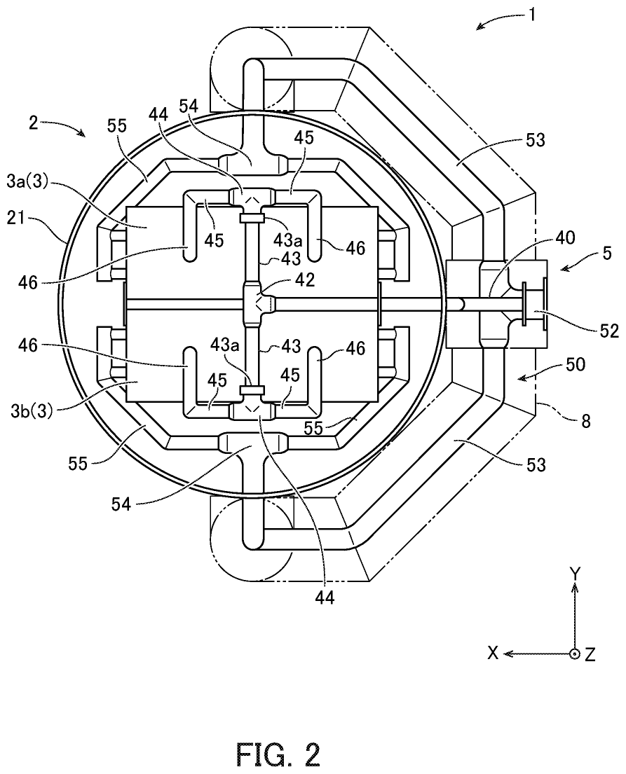

Hereinafter, a fuel cell module included in a fuel cell system according to the embodiments will be described. FIG. 1 is a perspective view illustrating an example of a fuel cell module included in a fuel cell system according to the embodiments. FIG. 2 is a plan view illustrating an example of a fuel cell module included in the fuel cell system according to the embodiments. In FIG. 2, a header 30 described later is omitted for convenience, and an inlet pipe 40 of a fuel gas pipe 4 and an inlet pipe 50 of an oxidant gas pipe 5 described later are illustrated. Note that the fuel cell module illustrated below is merely one non-limiting example, and may be modified appropriately.

As illustrated in FIGS. 1 and 2, a fuel cell module 1 according to the embodiments is configured such that a fuel cell cartridge 3 is disposed inside an airtight container 2. The airtight container 2 is formed into a bottomed cylindrical shape to cover the fuel cell cartridge 3. Specifically, the airtight container 2 is provided with a circular bottom wall (not illustrated), a cylindrical side wall 21 rising up from the perimeter of the bottom wall, and a circular top wall 22 that covers an opening above the side wall 21. The airtight container 2 is formed by a metal material such as stainless steel, for example.

The fuel cell cartridge 3 is constructed by installing a plurality of fuel cell stacks (not illustrated) in parallel (parallel installation), and has a rectangular cuboid shape overall. The fuel cell stacks are constructed by connecting solid oxide fuel cells (SOFC) in series, and is formed into a hollow cylindrical shape that is long in the vertical direction designated the Z direction in FIG. 1, for example. The plurality of fuel cell stacks are arranged at a predetermined pitch in the X and Y directions in FIG. 1, for example. Each solid oxide fuel cell has a basic configuration in which an electrolyte phase is disposed between an air electrode and a fuel electrode. An SOFC includes a power generation mechanism in which electrical energy is generated by causing oxide ions generated by an air electrode to pass through an electrolyte and move to a fuel electrode, such that the oxide ions react with hydrogen or carbon monoxide at the fuel electrode.

In the present embodiment, a single fuel cell cartridge 3 is configured in a rectangular cuboid shape having long rectangular shape in the X direction in a plan view. Also, two fuel cell cartridges 3 are arranged in the transverse direction designated the Y direction inside the airtight container 2. A first header 30 and a second header 31 for connecting to a fuel gas pipe 4 and an oxidant gas pipe 5 described later are provided on the upper and lower ends of the fuel cell cartridges 3. The first and second headers 30 and 31 have a generally rectangular cuboid shape. The fuel cell cartridges 3 supply a fuel gas and an oxidant gas to the fuel cell stacks through the first and second headers 30 and 31, and also discharge fuel off-gas and oxidant off-gas from the fuel cell stacks through the first and second headers 30 and 31. Note that the configuration and layout of the fuel cell stacks and the fuel cell cartridges 3 are not limited to the above and may be changed appropriately.

In addition, the fuel cell module 1 is provided with pipes that form flow channels for supplying the fuel gas or the oxidant gas to the fuel cell cartridges 3 as supply gas. Specifically, the pipes include a fuel gas pipe 4 that forms a fuel gas flow channel and an oxidant gas pipe 5 that forms an oxidant gas flow channel. City gas for example is used as the fuel gas and air for example is used as the oxidant gas. Note that the oxidant gas may also be air mixed with another gas. Moreover, the fuel gas may also be referred to as anode gas, and the oxidant gas may also be referred to as cathode gas.

The fuel gas pipe 4 includes an inlet pipe 40 and an outlet pipe 41. The inlet pipe 40 is disposed on the upper lateral surface of the side wall 21, and penetrates from the outside into the inside of the airtight container 2. On the upstream side of the inlet pipe 40, a fuel gas supply source not illustrated is connected. Also, as illustrated in FIG. 2, the inlet pipe 40 branches inside the airtight container 2 for each of the plurality of fuel cell cartridges 3. Specifically, the inlet pipe 40 includes a first branching part 42 that branches into two channels centrally above the fuel cell cartridges 3, a pair of first branch pipes 43 extending in the Y direction from the first branching part 42, second branching parts 44 that branch into two channels at the ends of the first branch pipes 43, a pair of second branch pipes 45 extending in the X direction from the second branching parts 44, and connecting pipes 46 that extend inwardly into the airtight container 2 (in the Y direction) from the ends of the second branch pipes 45 and also bend downward to connect to the upper end of each fuel cell cartridge 3.

In addition, the outlet pipe 41 is disposed on the lower end of each fuel cell cartridge 3. The outlet pipe 41 is disposed on the lower lateral surface of the side wall 21 and projects out from the inside of the airtight container 2 to the outside. The outlet pipe 41 has a branching pattern similar to the inlet pipe 40, and is configured such that the fuel off-gas (anode off-gas) that has been subjected to a reaction in the fuel cell cartridges 3 flows out from the airtight container 2.

The oxidant gas pipe 5 includes an inlet pipe 50 and an outlet pipe 51. The upstream side of the inlet pipe 50 is connected to an oxidant gas supply source not illustrated. Also, the inlet pipe 50 branches outside the airtight container 2 for each of the plurality of fuel cell cartridges 3. Specifically, the inlet pipe 50 includes a first branching part 52 that branches into two channels on the outside of the side wall 21 and a pair of first branch pipes 53 extending horizontally from the first branching part 52 along the outer surface of the side wall 21. The first branching part 52 is disposed directly above the outlet pipe 41 of the fuel gas pipe 4. The first branch pipes 53 each wrap around the side wall 21 and are connected internally from the lower lateral surface of the side wall 21 corresponding to the lateral surface in the longitudinal direction of each fuel cell cartridge 3.

As illustrated in FIG. 2, each first branch pipe 53 includes a second branching part 54 that branches into two channels inside the airtight container 2 and a pair of second branch pipes 55 extending horizontally from the second branching part 54 along the inner surface of the side wall 21. The second branch pipes 55 each wrap around the outside of the fuel cell cartridges 3 between the inner surface of the side wall 21 and the lateral surface of the fuel cell cartridges 3, and are connected to the lateral surface in the transverse direction of each fuel cell cartridge 3.

The outlet pipe 51 includes a pair of third branch pipes 56 projecting out from the upper lateral surface of the side wall 21 corresponding to the lateral surface in the longitudinal direction of each fuel cell cartridge 3, and a confluent part 57 that combines the pair of third branch pipes 56. The third branch pipes 56 wrap around the outer surface of the side wall 21 and are connected to the confluent part 57 on the outside of the side wall 21 corresponding to the lateral surface in the transverse direction of the fuel cell cartridges 3. The confluent part 57 is positioned directly below the inlet pipe 40 of the fuel gas pipe 4. Note that for convenience, the configuration of the outlet pipe 51 inside the airtight container 2 is omitted.

As illustrated in FIG. 1, tubular heat-insulating covers 6 and 7 are provided to cover the outer circumference of the inlet pipe 40 and the outlet pipe 41 forming the fuel gas pipe 4. In addition, tubular heat-insulating covers 8 and 9 are provided on the inlet pipe 50 and the outlet pipe 51 forming the oxidant gas pipe 5. These heat-insulating covers are formed by a metal material such as stainless steel like the airtight container 2, and are formed having a predetermined gap with respect to the outer circumferential surface of each pipe. For example, by disposing a high-temperature heat-insulating material (not illustrated) such as glass wool between the heat-insulating covers and the pipes, the diffusion of heat from the pipes to the outside can be prevented. Note that a heat-insulating material may also be provided on the outer circumferential side of the heat-insulating covers. Also, the heat-insulating material may be affixed by winding a metal wire of a certain wire gauge.

In the fuel cell module 1 configured in this way, a fuel gas from the fuel gas supply source is supplied to the fuel cell cartridges 3 through the fuel gas pipe 4. On the other hand, an oxidant gas from the oxidant gas supply source is supplied to the fuel cell cartridges 3 through the oxidant gas pipe 5. By inducing a chemical reaction between the fuel gas and the oxidant gas inside the fuel cell cartridges 3, electrical energy (direct-current power) is generated. The generated direct-current power is converted into alternating-current power by an inverter not illustrated, for example. The fuel gas and the oxidant gas after the reaction are discharged to the outside of the fuel cell module 1 through respective pipes.

Incidentally, in the case where the fuel cell module 1 is provided with a plurality of fuel cell cartridges 3, achieving a uniform flow rate of the fuel to each of the fuel cell cartridges 3 (uniform distribution) is important for preventing degradation of the fuel cell stacks (and furthermore the fuel cells forming the fuel cell stacks). Preferably, a uniform flow rate of the fuel to the fuel cell cartridges 3 is achieved without increasing the overall bulk or the manufacturing costs of the fuel cell module 1. In particular, in the case of applying the present invention to a solid oxide fuel cell (SOFC) or a molten carbonate fuel cell (MCFC) for example, the fuel cell stacks contain ceramic, which makes it difficult to achieve uniform dimensions after firing the ceramic. For this reason, there is a limit to achieving uniform dimensions by design, and inconsistencies in the fuel flow rate occur among the fuel cell cartridges (the same also applies to the oxidant gas). This problem is especially pronounced for a solid oxide fuel cell (SOFC) in which the highest operating point is approximately 1000° C. and the firing temperature of the cell stack exceeds 1500° C.

The inventions focused on how in the fuel cell module 1, non-uniform flow rates of the fuel gas flowing through the plurality of fuel cell cartridges 3 affects the uniformity of the fuel flow rate. Furthermore, the inventors discovered that matching the flow rates of the fuel gas among the fuel cell cartridges contributes to achieving a uniform flow rate with respect to the fuel cell cartridges 3, and thereby conceived of the present invention.

In other words, the gist of the fuel cell system according to the present invention is to match the flow rates of the fuel gas among the fuel cell cartridges by installing a flexible pipe as a part of an adjustment member that adjusts the flow rate of the fuel gas or the fuel off-gas in at least one of the fuel gas supply line that supplies the fuel gas to the plurality of fuel cell cartridges 3 or the fuel off-gas discharge line that discharges the fuel off-gas from the plurality of fuel cell cartridges.

According to the fuel cell system according to the present invention, because a flexible pipe is installed as a part of an adjustment member that adjusts the flow rate of the fuel gas or the fuel off-gas in at least one of the fuel gas supply line or the fuel off-gas discharge line, it is possible to match the flow rates of the fuel gas among the fuel cell cartridges, thereby making it possible to achieve a uniform flow rate of the fuel with respect to the plurality of fuel cell cartridges.

Hereinafter, configurations of the fuel cell system according to embodiments of the present invention will be described.

### First Embodiment

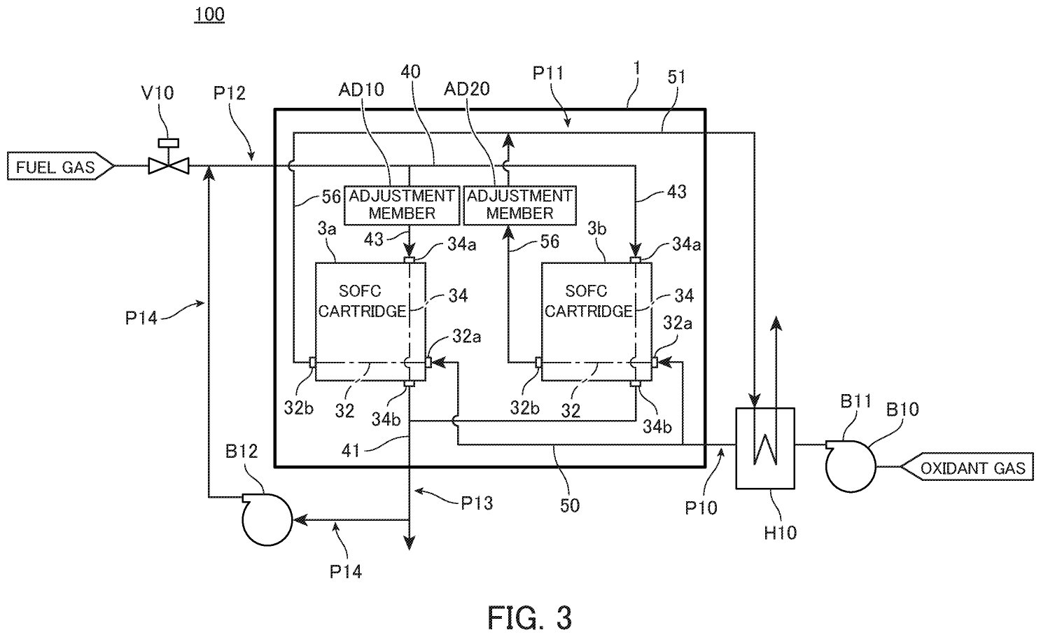

FIG. 3 is a block diagram illustrating a configuration of a fuel cell system 100 according to a first embodiment. For convenience, only the components related to the present invention are illustrated in FIG. 3. Note that in FIG. 3, components shared in common with FIG. 1 are denoted with the same signs and further description of such components is omitted. In FIG. 3, the flow channels of fluids such as the fuel gas and the oxidant gas are illustrated by solid lines. Note that the flow channels of fluids inside the SOFC cartridges 3 are illustrated by chain lines for convenience.

As illustrated in FIG. 3, the fuel cell system 100 includes the fuel cell module 1. The fuel cell module 1 is provided with a pair of fuel cell cartridges (hereinafter referred to as the “SOFC cartridges”) 3 (3a, 3b). Note that because the SOFC cartridges 3a and 3b share a common configuration, the SOFC cartridge 3a will be described as a representative example. The SOFC cartridge 3a includes an oxidant gas flow channel (cathode gas flow channel) 32 and a fuel gas flow channel (anode gas flow channel) 34.

The oxidant gas (air) and other gases brought in by a reaction air blower (oxidant gas supplier) B10 are supplied to an inlet 32a of the oxidant gas flow channel 32, and oxidant off-gas is discharged from an outlet 32b of the oxidant gas flow channel 32. The oxidant gas (air) is supplied to the inlet 32a of the oxidant gas flow channel 32 through an oxidant gas supply line P10 that connects an outlet B11 of the reaction air blower B10 to the inlet 32a of the oxidant gas flow channel 32. Additionally, the oxidant off-gas is discharged from the outlet 32b of the oxidant gas flow channel 32 through an oxidant gas discharge line P11 connected to the outlet 32b of the oxidant gas flow channel 32.

A fuel gas (fuel) and other gases are supplied to an inlet 34a of the fuel gas flow channel 34 from a fuel gas supplier (not illustrated). Fuel off-gas is discharged from an outlet 34b of the fuel gas flow channel 34. The fuel gas (fuel) is supplied to the inlet 34a of the fuel gas flow channel 34 through a fuel gas supply line P12 that connects a valve V10 to the inlet 34a of the fuel gas flow channel 34. Additionally, the fuel off-gas is discharged from the outlet 34b of the fuel gas flow channel 34 through a fuel gas discharge line P13 connected to the outlet 34b of the fuel gas flow channel 34.

In the fuel cell system 100, a heat exchanger H10 is connected to the oxidant gas supply line P10 and the oxidant gas discharge line P11. The heat exchanger H10 transfers heat from the oxidant off-gas flowing through the oxidant gas discharge line P11 to the oxidant gas flowing through the oxidant gas supply line P10. With this arrangement, the oxidant gas (air) brought in by the reaction air blower B10 is heated by the heat exchanger H10 and supplied to the inlet 32a of the oxidant gas flow channel 32.

Also, on the outside of the fuel cell module 1, a fuel gas recirculation line P14 is connected to the fuel gas discharge line P13 and the fuel gas supply line P12. The fuel gas recirculation line P14 is provided with a blower B12 that recirculates the fuel off-gas. A portion of the fuel off-gas discharged from the SOFC cartridges 3a and 3b to the fuel gas discharge line P13 is introduced into the fuel gas recirculation line P14 by the blower B12 and sent to the fuel gas supply line P12. With this arrangement, the fuel gas (fuel) from the fuel gas supplier (not illustrated) is heated by being mixed with the fuel off-gas, and is supplied to the inlet 34a of the fuel gas flow channel 34. Also, moisture generated at the fuel electrode in association with the recirculation of the fuel off-gas is usable as reforming water for the fuel gas, and consequently a configuration for supplying reforming steam from an external source while the fuel cell module 1 is in operation can be omitted. As a result, a more compact fuel cell system can be achieved and the manufacturing costs can be lowered.

In the fuel cell system 100 illustrated in FIG. 3, the oxidant gas supply line P10 includes the inlet pipe 50 of the oxidant gas pipe 5 while the oxidant gas discharge line P11 includes the outlet pipe 51 of the oxidant gas pipe 5, for example (see FIG. 1). Similarly, the fuel gas supply line P12 includes the inlet pipe 40 of the fuel gas pipe 4 while the fuel gas discharge line P13 includes the outlet pipe 41 of the fuel gas pipe 4.

In the fuel cell system 100, of the inlet pipe 40 of the fuel gas pipe 4, the first branch pipes 43 connected to the SOFC cartridge 3a are provided with a flow rate adjustment member (hereinafter simply referred to as the “adjustment member”) AD10 (see FIG. 3). The adjustment member AD10 includes a member that adjusts the flow rate of the fuel gas flowing through the inlet pipe 40 (first branch pipes 43) of the fuel gas pipe 4 toward the SOFC cartridge 3a. The adjustment member AD10 constitutes one example of a first adjustment member. Note that the adjustment member AD10 may also be referred to as a resistive element with respect to the fuel gas flowing through the first branch pipes 43. The same applies to other adjustment members.

Any member can be selected as the adjustment member AD10 on the condition that the flow rate of the fuel gas flowing through the inlet pipe 40 (first branch pipes 43) of the fuel gas pipe 4 is adjusted. For example, the adjustment member AD10 includes a flexible pipe, an orifice, a control valve, or a combination of the above. In the present embodiment, flexible pipes are used as the first branch pipes 43, and in addition, the adjustment member AD10 includes an orifice 43a disposed between the first branch pipes 43 and the second branching parts 44 (see FIG. 2).

By using flexible pipes to construct the adjustment member AD10, the flow rate of the fuel gas in the inlet pipe 40 can be adjusted while absorbing the thermal expansion of the pipes associated with the operation of the fuel cell module 1. Note that the flow rate of the fuel gas can be adjusted on the basis of measured data obtained while the fuel cell module 1 is in operation. For example, in the case of using flexible pipes to construct the adjustment member AD10, the flow rate of the fuel gas can be adjusted by selecting the length and degree of bend in the flexible pipes on the basis of the measured data.

For example, in the case where the flow rate in the first branch pipe 43 connected to the SOFC cartridge 3a is lower than the flow rate in the first branch pipe 43 connected to the SOFC cartridge 3b, the resistance to the fluid flowing through the first branch pipe 43 is increased to lower the flow rate. For example, in the case of using flexible pipes to construct the adjustment member AD10, the resistance to the fluid flowing through the first branch pipe 43 is increased by extending the length or bending the shape of the flexible pipe.

Conversely, in the case where the flow rate in the first branch pipe 43 connected to the SOFC cartridge 3a is higher than the flow rate in the first branch pipe 43 connected to the SOFC cartridge 3b, the resistance to the fluid flowing through the first branch pipe 43 is decreased to lower the flow rate. For example, in the case of using flexible pipes to construct the adjustment member AD10, the resistance to the fluid flowing through the first branch pipe 43 is decreased by straightening the shape of the flexible pipe.

Note that the adjustment member AD10 may also be constructed by changing the pattern of the inlet pipe 40 in a corresponding location. For example, the adjustment member AD10 may be constructed by changing the pipe diameter or the pipe length in a location corresponding to the adjustment member AD10, or by performing bending work in a location corresponding to the adjustment member AD10. By constructing the adjustment member AD10 by changing the pattern of the corresponding location in this way, increases in the costs for manufacturing the fuel gas pipe 4 can be reduced.

In this way, in the fuel cell system 100 according to the first embodiment, the fuel gas pipe 4 connected to the SOFC cartridge 3a is provided with the adjustment member AD10 that adjusts the flow rate of the fuel gas. With this arrangement, the flow rates of the fuel gas flowing through the inlet pipe 40 of the fuel gas pipe 4 connected to the SOFC cartridges 3a and 3b can be matched, and therefore a uniform flow rate of the fuel with respect to the SOFC cartridges 3a and 3b can be achieved. As a result, degradation of the SOFC stacks (and furthermore the SOFC cells forming the SOFC stacks) due to non-uniform fuel flow rates with respect to the SOFC cartridges 3 can be prevented, thereby making it possible to achieve stable, high-capacity power generation.

In particular, the adjustment member AD10 is provided in the fuel gas pipe 4 connected to the SOFC cartridges 3 and the flow rate of the fuel gas flowing through the fuel gas pipe 4 is adjusted, thereby making it possible to suppress increases in the costs associated with manufacturing the fuel gas pipe 4 compared to the case of adjusting the flow rate of the fuel gas with respect to the SOFC stacks forming the SOFC cartridges 3, or moreover the SOFC cells forming the SOFC stacks. As a result, a uniform flow rate of the fuel with respect to the SOFC cartridges 3 can be achieved while also keeping manufacturing costs down.

Additionally, in the fuel cell system 100, of the outlet pipe 51 of the oxidant gas pipe 5, the third branch pipes 56 connected to the SOFC cartridge 3b are provided with an adjustment member AD20. The adjustment member AD20 is configured using a member similar to the adjustment member AD10, and includes a member that adjusts the flow rate of the oxidant gas flowing through the outlet pipe 51 (third branch pipes 56) of the oxidant gas pipe 5. The adjustment member AD20 constitutes one example of a second adjustment member.

By adjusting the flow rate of the oxidant gas flowing the third branch pipes 56 with the adjustment member AD20, the flow rates of the oxidant off-gas flowing through both of the third branch pipes 56 connected to the SOFC cartridges 3a and 3b can be matched. Consequently, a uniform flow rate of the oxidant off-gas discharged from the SOFC cartridges 3a and 3b can be achieved. As a result, a situation in which the temperature of one of the SOFC cartridges 3 rises because of non-uniform flow rates of the oxidant off-gas from the SOFC cartridges 3 can be avoided, and damage or the like to the SOFC cartridges 3 can be prevented.

### Second Embodiment

A fuel cell system according to a second embodiment differs from the fuel cell system 100 according to the first embodiment in the number of flow rate adjustment members disposed in the inlet pipe 40 of the fuel gas pipe 4 and the number of flow rate adjustment members disposed in the outlet pipe 51 of the oxidant gas pipe 5.

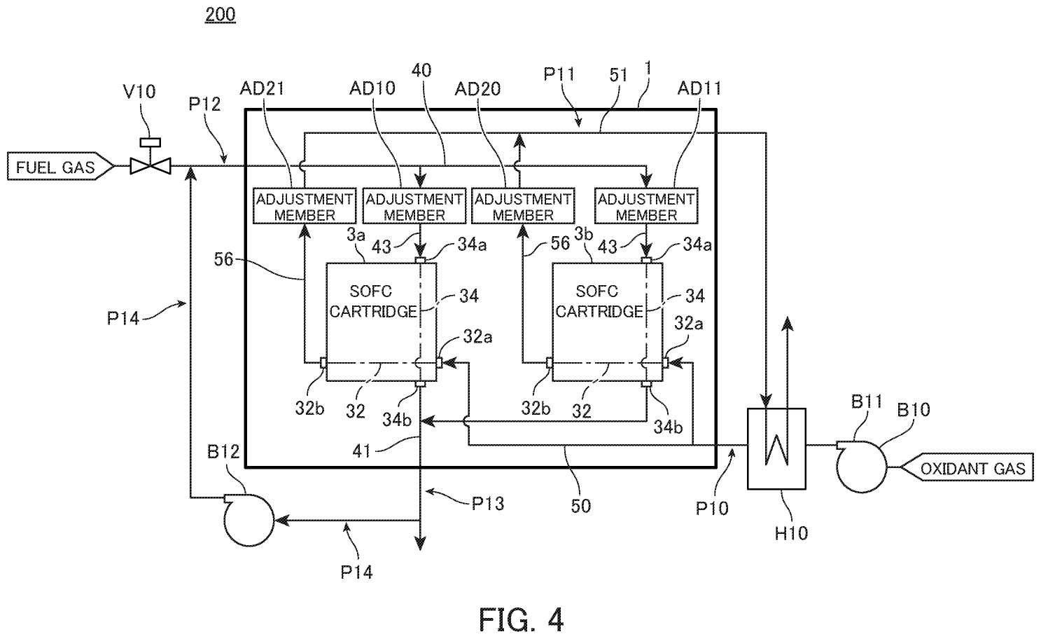

Hereinafter, the configuration of the fuel cell system according to the second embodiment will be described while mainly focusing on the points that differ from the fuel cell system 100 according to the first embodiment. FIG. 4 is a block diagram illustrating a configuration of a fuel cell system 200 according to the second embodiment. Note that in FIG. 4, components shared in common with FIG. 3 are denoted with the same signs and further description of such components is omitted.

As illustrated in FIG. 4, in the fuel cell system 200, an adjustment member AD11 is provided in addition to the adjustment member AD10 in the first branch pipes 43 of the inlet pipe 40 of the fuel gas pipe 4. Like the adjustment member AD10, the adjustment member AD11 includes a member that adjusts the flow rate of the fuel gas flowing through the inlet pipe 40 (first branch pipes 43) of the fuel gas pipe 4 toward the SOFC cartridge 3b. Note that the adjustment members AD10 and AD11 may be configured using the same member or different members.

In the fuel cell system 200 according to the second embodiment, the flow rate of the fuel gas flowing through the first branch pipes 43 is adjusted by both the adjustment member AD10 and the adjustment member AD11. Consequently, the flow rate in the inlet pipe 40 overall can be adjusted more effectively compared to the case of adjusting the flow rate in the inlet pipe 40 with the adjustment member AD10 alone. With this arrangement, a uniform flow rate of the fuel gas with respect to the SOFC cartridges 3a and 3b can be achieved with high precision.

Also, in the fuel cell system 200, of the outlet pipe 51 of the oxidant gas pipe 5, the third branch pipes 56 are provided with an adjustment member AD21 in addition to the adjustment member AD20. Like the adjustment member AD20, the adjustment member AD21 includes a member that adjusts the flow rate of the oxidant gas flowing through the outlet pipe 51 (third branch pipes 56) of the oxidant gas pipe 5. Note that the adjustment members AD20 and AD21 may be configured using the same member or different members.

In the fuel cell system 200 according to the second embodiment, the flow rate of the oxidant gas flowing through the third branch pipes 56 is adjusted by both the adjustment member AD20 and the adjustment member AD21. Consequently, the flow rate in the outlet pipe 51 overall can be adjusted more effectively compared to the case of adjusting the flow rate in the outlet pipe 51 with the adjustment member AD20 alone. With this arrangement, a uniform flow rate of the oxidant off-gas discharged from the SOFC cartridges 3a and 3b can be achieved with high precision.

### Third Embodiment

A fuel cell system according to a third embodiment differs from the fuel cell system 200 according to the second embodiment in that an adjustment valve is included in the flow rate adjustment members disposed in the inlet pipe 40 of the fuel gas pipe 4 and the outlet pipe 51 of the oxidant gas pipe 5, and the adjustment valves are controlled on the basis of the state of the fuel cell module 1. Additionally, the fuel cell system according to the third embodiment differs from the fuel cell system 200 according to the second embodiment in that an adjustment valve is disposed externally to the fuel cell module 1 to ensure the operation of the adjustment valves as flow rate adjustment members. Due to the arrangement of the adjustment valve external to the fuel cell module 1, the paths of the inlet pipe 40 of the fuel gas pipe 4 and the outlet pipe 51 of the oxidant gas pipe 5 are partially changed.

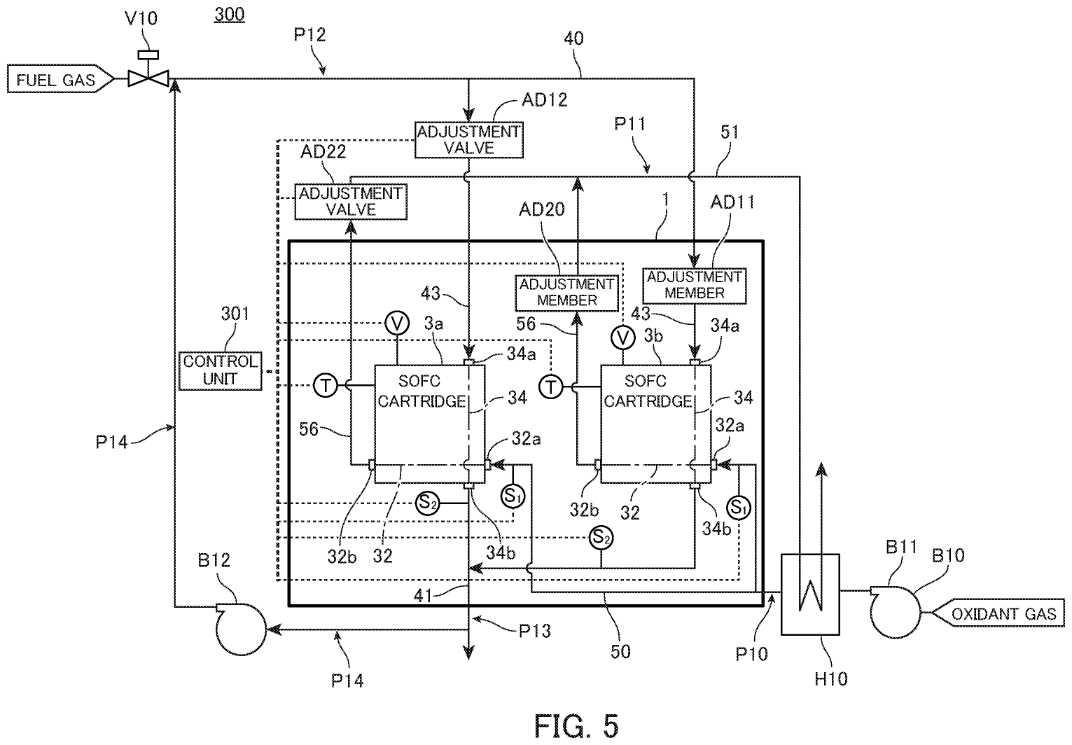

Hereinafter, the configuration of the fuel cell system according to the third embodiment will be described while mainly focusing on the points that differ from the fuel cell system 200 according to the second embodiment. FIG. 5 is a block diagram illustrating a configuration of a fuel cell system 300 according to the third embodiment. Note that in FIG. 5, components shared in common with FIG. 4 are denoted with the same signs and further description of such components is omitted. Also, in FIG. 5, the flow channels of fluids such as the fuel gas and the oxidant gas are illustrated by solid lines, and signal lines of control signals in the fuel cell system 300 are illustrated by dashed lines.

As illustrated in FIG. 5, in the fuel cell system 300, an adjustment valve AD12 is provided instead of the adjustment member AD10 in the first branch pipe 43 connected to the SOFC cartridge 3a of the inlet pipe 40 of the fuel gas pipe 4. In the fuel cell system 300, because the adjustment valve AD12 is installed in the first branch pipe 43, unlike the fuel cell system 200 according to the second embodiment, a portion of the first branch pipe 43 is configured to be exposed to the outside of the fuel cell module 1. Under control by a control unit 301 described later, the adjustment valve AD12 adjusts the flow rate of the fuel gas flowing through the inlet pipe 40 (first branch pipe 43) of the fuel gas pipe 4 toward the SOFC cartridge 3a.

Additionally, in the fuel cell system 300, of the outlet pipe 51 of the oxidant gas pipe 5 the third branch pipe 56 connected to the SOFC cartridge 3b is provided with an adjustment valve AD22 instead of the adjustment member AD21. Like the adjustment valve AD12, the adjustment valve AD22 adjusts the flow rate of the oxidant gas flowing through the outlet pipe 51 (third branch pipe 56) of the oxidant gas pipe 5 under control by the control unit 301 described later.

The fuel cell system 300 is provided with a temperature sensor T that detects the internal temperature of the SOFC cartridges 3a and 3b and a voltage sensor V that detects the voltage of the SOFC cartridges 3a and 3b. In addition, a concentration sensor (first concentration detection unit) S1 that detects the oxygen concentration is provided in the oxidant gas supply line P10 leading to the SOFC cartridges 3a and 3b. Furthermore, a concentration sensor (second concentration detection unit) S2 that detects the fuel off-gas concentration is provided in the fuel gas discharge line P13 from the SOFC cartridges 3a and 3b. The temperature sensor T, the voltage sensor V, and the concentration sensors S1 and S2 output detection results to the control unit 301 described later.

Also, the fuel cell system 300 is provided with the control unit 301 that controls the adjustment valves AD12 and AD22. The control unit 301 controls the adjustment valve AD12 and/or the adjustment valve AD22 on the basis of the various detection results received from the temperature sensor T, the voltage sensor V, and the concentration sensors S1 and S2. For example, the control unit 301 controls the adjustment valve AD22 on the basis of the detection result from the temperature sensor T and/or the concentration sensor S1. With this arrangement, as a result of adjusting the flow rate in the outlet pipe 51 of the oxidant gas pipe 5, the flow rate of the air (oxidant gas) from the SOFC cartridges 3a and 3b is adjusted. In addition, the control unit 301 controls the adjustment valve AD12 on the basis of the detection result from the voltage sensor V and/or the concentration sensor S2. With this arrangement, as a result of adjusting the flow rate in the inlet pipe 40 of the fuel gas pipe 4, the flow rate of the fuel gas to the SOFC cartridges 3a and 3b is adjusted.

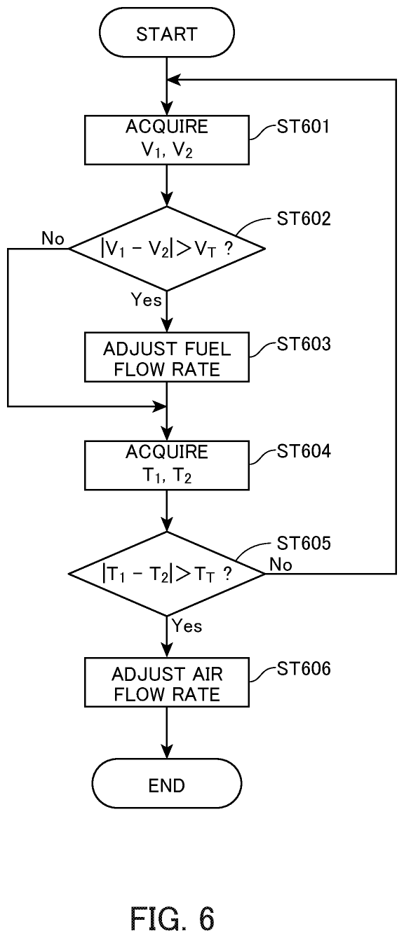

Here, the operations of controlling the adjustment valves AD12 and AD22 in the fuel cell system 300 will be described with reference to FIG. 6. FIG. 6 is a flowchart for describing the control of the adjustment valves AD12 and AD22 in the fuel cell system 300 according to the third embodiment. Note that in FIG. 6, the case of controlling the adjustment valves AD12 and AD22 on the basis of the detection results from the voltage sensor V and the temperature sensor T is described for convenience.

In the fuel cell system 300, when power generation by the fuel cell module 1 is started, the control unit 301 determines the possibility of degradation in the SOFC cartridges 3a and 3b. At this point, the control unit 301 acquires voltage values V₁ and V₂ from the voltage sensor V connected to the SOFC cartridges 3a and 3b (step (hereinafter designated “ST”) 601). Additionally, the control unit 301 determines whether the absolute value of the difference between the voltage values V₁ and V₂ is greater than a predetermined voltage value V_{T} (ST602).

In the case where the absolute value of the difference between the voltage values V₁ and V₂ is greater than the voltage value V_{T} (ST602: Yes), the control unit 301 determines that there is a possibility of degradation in the SOFC cartridges 3a and 3b. The determination is made in consideration of the property that the voltage values V₁ and V₂ in the SOFC cartridges 3a and 3b rise according to the concentration of the supplied fuel gas. If one of the voltage values V₁ and V₂ in the SOFC cartridges 3a and 3b is low, the possibility that the SOFC cartridge 3 with the low voltage value has degraded or is degrading is inferred. Consequently, the control unit 301 uses the adjustment valve AD12 to adjust the flow rate in the inlet pipe 40 and thereby adjust the flow rate of the fuel supplied to the SOFC cartridges 3a and 3b (ST603).

Here, by adjusting the flow rate of the fuel supplied to the SOFC cartridges 3a and 3b, a uniform flow rate of the fuel supplied to the SOFC cartridges 3a and 3b is achieved. This arrangement makes it possible to avoid a situation in which a reduced quantity of the fuel is supplied to the SOFC cartridge 3a or 3b recognized as having a low voltage value according to the voltage sensor V, and inhibit the progression of degradation in the affected SOFC cartridge 3.

After adjusting the flow rate of the fuel supplied to the SOFC cartridges 3a and 3b in ST603, or in the case where the absolute value of the difference between the voltage values V₁ and V₂ is the voltage value V_{T} or less (ST602: No), the control unit 301 determines the possibility of damage to the SOFC cartridges 3a and 3b. At this point, the control unit 301 acquires temperatures T₁ and T₂ from the temperature sensor T connected to the SOFC cartridges 3a and 3b (ST604). Additionally, the control unit 301 determines whether the absolute value of the difference between the temperatures T₁ and T₂ is greater than a predetermined temperature T_{T} (ST605).

In the case where the absolute value of the difference between the temperatures T₁ and T₂ is greater than the temperature T_{T} (ST605: Yes), the control unit 301 determines that there is a possibility of damage to the SOFC cartridges 3a and 3b. The determination is made in consideration of how the SOFC cartridges 3a and 3b may be damaged if the temperatures T₁ and T₂ rise to an extreme degree. If one of the temperatures T₁ and T₂ in the SOFC cartridges 3a and 3b is low, the possibility of damage to the SOFC cartridge 3 with the high temperature is inferred. Consequently, the control unit 301 uses the adjustment valve AD22 to adjust the flow rate in the outlet pipe 51 and thereby adjust the flow rate of the air (oxidant off-gas) discharged from the SOFC cartridges 3a and 3b (ST606).

Here, by adjusting the flow rate of the air (oxidant off-gas) discharged from the SOFC cartridges 3a and 3b, a uniform flow rate of the air supplied to the SOFC cartridges 3a and 3b is achieved. This arrangement makes it possible to avoid a situation in which the temperature rises to an extreme degree in the SOFC cartridge 3a or 3b recognized as having a high temperature according to the temperature sensor T, and deter damage to the affected SOFC cartridge 3.

On the other hand, in the case where the absolute value of the difference between the temperatures T₁ and T₂ is the temperature T_{T} or less (ST605: No), the control unit 301 returns the process to ST601 and repeats the process from ST601 to ST606. In other words, the control unit 301 repeats the processes for determining the possibility of degradation in the SOFC cartridges 3a and 3b and the possibility of damage to the SOFC cartridges 3a and 3b. After adjusting the flow rate of the air discharged from the SOFC cartridges 3a and 3b in ST606, the control unit 301 ends the series of operations. Thereafter, after the operations end, the control illustrated in FIG. 6 is executed again after a certain time elapses, for example.

In this way, in the fuel cell system 300 according to the third embodiment, the flow rate of the fuel gas flowing through the inlet pipe 40 (first branch pipes 43) of the fuel gas pipe 4 is adjusted on the basis of the voltage values of the SOFC cartridges 3a and 3b. With this arrangement, the flow rate of the fuel gas can be adjusted flexibly according to the voltage conditions in the SOFC cartridges 3a and 3b, and a uniform flow rate of the fuel gas with respect to the SOFC cartridges 3a and 3b can be achieved with high precision.

Moreover, in the fuel cell system 300 according to the third embodiment, the flow rate of the oxidant off-gas flowing through the outlet pipe 51 (third branch pipes 56) of the oxidant gas pipe 5 is adjusted on the basis of the temperatures of the SOFC cartridges 3a and 3b. With this arrangement, the flow rate of the oxidant off-gas can be adjusted flexibly according to the temperature conditions in the SOFC cartridges 3a and 3b, and a uniform flow rate of the oxidant off-gas discharged from the SOFC cartridges 3a and 3b can be achieved with high precision.

The flowchart illustrated in FIG. 6 is used to describe the case of controlling the adjustment valves AD12 and AD22 on the basis of the detection results from the voltage sensor V and the temperature sensor T. However, the detection results from the sensors used when controlling the adjustment valves AD12 and AD22 are not limited to the above and may be changed appropriately. For example, the control unit 301 may also control the adjustment valve AD22 on the basis of the detection result from the concentration sensor S1 and control the adjustment valve AD12 on the basis of the detection result from the concentration sensor S2. Even in the case of controlling the adjustment valves AD12 and AD22 by using the detection results from the concentration sensors S1 and S2 in this way, effects similar to the above embodiment can be obtained.

Note that the present invention is not limited to the embodiments described above, and various modifications are possible. In the embodiments described above, properties such as the sizes, shapes, and functions of the components illustrated in the accompanying drawings are not limited to what is illustrated, and such properties may be modified appropriately insofar as the effects of the present invention are still achieved. Otherwise, other appropriate modifications are possible without departing from the scope of the present invention.

For example, in the fuel cell system 300 according to the third embodiment above, a case is described in which the adjustment valve AD22 is disposed in the outlet pipe 51 (third branch pipes 56) of the oxidant gas pipe 5 and the flow rate of the oxidant off-gas flowing through the outlet pipe 51 is adjusted. However, the placement of the adjustment valve AD22 is not limited to the above and may be changed appropriately.

For example, the adjustment valve AD22 may also be provided in a portion of the oxidant gas supply line P10 (inlet pipe 50 of the oxidant gas pipe 5). In this case, the adjustment valve AD22 may be disposed inside the fuel cell module 1 or outside the fuel cell module 1. In the former case, the adjustment valve AD22 is provided in the second branch pipes 55 of the inlet pipe 50, and in the latter case, the adjustment valve AD22 is provided in the first branch pipes 53 of the inlet pipe 50. In the case where the adjustment valve AD22 is provided outside the fuel cell module 1 (in the first branch pipes 53 of the inlet pipe 50), it is not necessary to make a space for disposing the adjustment valve AD22 in the fuel cell module 1, and consequently the dimensions of the fuel cell module 1 can be reduced.

Note that although the above examples describe a solid oxide fuel cell (SOFC), the present invention is not limited thereto, and obviously the present invention is applicable to any fuel cell having headers for respectively supplying or discharging a fuel gas and an oxidant gas to a plurality of fuel cell stacks. Such fuel cells include a polymer electrolyte fuel cell (PEFC), a phosphoric acid fuel cell (PAFC), and a molten carbonate fuel cell (MCFC), for example.

Features of the above embodiments are summarized below. The fuel cell system described in the above embodiments is a fuel cell system using a plurality of fuel cell stacks each of which includes a plurality of fuel cells that generate electricity through an electrochemical reaction between a fuel gas and an oxidant gas connected in series, the fuel cell system comprising a plurality of fuel cell cartridges in which the fuel cell stacks are connected in parallel and provided with headers so as to respectively supply the fuel gas and the oxidant gas to the plurality of fuel cell stacks through the headers and also respectively discharge a fuel off-gas and an oxidant off-gas through the headers, a fuel gas supply line that supplies the fuel gas to the plurality of fuel cell cartridges, a fuel off-gas discharge line that discharges the fuel off-gas from the plurality of fuel cell cartridges, and a first adjustment member, provided in at least one of the fuel gas supply line or the fuel off-gas discharge line, that adjusts a flow rate of the fuel gas or the fuel off-gas, wherein at least one portion of the first adjustment member includes a flexible pipe.

Also, the fuel cell system described in the above embodiments further comprises an oxidant gas supply line that supplies the oxidant gas to the fuel cell cartridges, an oxidant gas discharge line that discharges the oxidant off-gas from the fuel cell cartridges, and a second adjustment member, provided in at least one of the oxidant gas supply line or the oxidant gas discharge line, that adjusts a flow rate of the oxidant gas or the oxidant off-gas, wherein at least one portion of the second adjustment member includes a flexible pipe.

Also, the fuel cell system described in the above embodiments further comprises an adjustment valve provided in at least portion of the first adjustment member or the second adjustment member.

Also, the fuel cell system described in the above embodiments further comprises a control unit that controls the adjustment valve.

Also, the fuel cell system described in the above embodiments further comprises a temperature detection unit that detects a temperature of the fuel cell cartridges, wherein the control unit controls the adjustment valve according to a detection result from the temperature detection unit.

Also, the fuel cell system described in the above embodiments further comprises a voltage detection unit that detects a voltage of the fuel cell cartridges, wherein the control unit controls the adjustment valve according to a detection result from the voltage detection unit.

Also, the fuel cell system described in the above embodiments further comprises a first concentration detection unit that detects a concentration of the oxidant gas discharged from the fuel cell cartridges, wherein the control unit controls the adjustment valve according to a detection result from the first concentration detection unit.

Also, the fuel cell system described in the above embodiments further comprises a second concentration detection unit that detects a concentration of the fuel gas supplied to the fuel cell cartridges, wherein the control unit controls the adjustment valve according to a detection result from the second concentration detection unit.

Also, in the fuel cell system described in the above embodiments, solid oxide fuel cells are included as the fuel cells.

### INDUSTRIAL APPLICABILITY

As described above, the present invention is effective at achieving a uniform flow rate of a fuel with respect to fuel cell cartridges, and is particularly useful in a fuel cell system provided with a solid oxide fuel cell module.

This application is based on Japanese Patent Application No. 2019-234467 filed on Dec. 25, 2019, the content of which is hereby incorporated in entirety.

What is claimed is:

1. A fuel cell system, comprising:
a plurality of fuel cell stacks, each of which includes a plurality of fuel cells that are connected in series and generate electricity through an electrochemical reaction between a fuel gas and an oxidant gas;
a plurality of fuel cell cartridges, each of which has a first header that supplies the fuel gas and the oxidant gas to the plurality of fuel cell stacks and a second header that discharges a fuel off-gas and an oxidant off-gas from the plurality of fuel cell stacks;
a fuel gas supply line that supplies the fuel gas to the plurality of fuel cell cartridges;
a fuel off-gas discharge line that discharges the fuel off-gas from the plurality of fuel cell cartridges; and
a first adjustment member provided in at least one of the fuel gas supply line or the fuel off-gas discharge line, and adjusting a flow rate of the fuel gas or the fuel off-gas, the first adjustment member including a first flexible pipe.

2. The fuel cell system according to claim 1, further comprising:
an oxidant gas supply line that supplies the oxidant gas to the fuel cell cartridges;
an oxidant gas discharge line that discharges the oxidant off-gas from the fuel cell cartridges; and
a second adjustment member provided in at least one of the oxidant gas supply line or the oxidant gas discharge line, and adjusting a flow rate of the oxidant gas or the oxidant off-gas, the second adjustment member including a second flexible pipe.

3. The fuel cell system according to claim 1, wherein the first adjustment member further includes an adjustment valve.

4. The fuel cell system according to claim 2, wherein the second adjustment member further includes an adjustment valve.

5. The fuel cell system according to claim 3, further comprising a control unit that controls the adjustment valve.

6. The fuel cell system according to claim 5, further comprising a temperature detection unit that detects a temperature of the fuel cell cartridges, wherein the control unit controls the adjustment valve according to a detection result provided by the temperature detection unit.

7. The fuel cell system according to claim 5, further comprising a voltage detection unit that detects a voltage of the fuel cell cartridges, wherein
the control unit controls the adjustment valve according to a detection result provided by the voltage detection unit.

8. The fuel cell system according to claim 5, further comprising a first concentration detection unit that detects a concentration of the oxidant gas discharged from the fuel cell cartridges, wherein
the control unit controls the adjustment valve according to a detection result provided by the first concentration detection unit.

9. The fuel cell system according to claim 5, further comprising a second concentration detection unit that detects a concentration of the fuel gas supplied to the fuel cell cartridges, wherein
the control unit controls the adjustment valve according to a detection result provided by the second concentration detection unit.

10. The fuel cell system according to claim 1, wherein the fuel cells each include a solid oxide fuel cell.
